(19) United States
(12) Patent Application Publication
(10) Pub. No.: US 2012/0316998 A1
(43) Pub. Date: Dec. 13, 2012

(54) SYSTEM AND METHOD FOR STORING AND ACCESSING MEMORABILIA

(76) Inventor: George A. Castineiras, Farmington, CT (US)

(21) Appl. No.: 13/495,450

(22) Filed: Jun. 13, 2012

Related U.S. Application Data
(63) Continuation-in-part of application No. 12/975,928, filed on Dec. 22, 2010.
Application No. 12/975,928 is a continuation-in-part of application No. 11/867,745, filed on Oct. 5, 2007, now abandoned.
Application No. 11/867,745 is a continuation-in-part of application No. 11/863,931, filed on Sep. 28, 2007, now abandoned.
Application No. 11/863,931 is a continuation-in-part of application No. 11/854,577, filed on Sep. 13, 2007, now abandoned.
Application No. 11/854,577 is a continuation-in-part of application No. 11/652,998, filed on Jan. 12, 2007, now abandoned.
Application No. 11/652,998 is a continuation-in-part of application No. 11/490,726, filed on Jul. 21, 2006, now abandoned.
Application No. 11/490,726 is a continuation-in-part of application No. 11/396,895, filed on Apr. 3, 2006, now abandoned.
Application No. 11/396,895 is a continuation-in-part of application No. 11/168,651, filed on Jun. 27, 2005, now abandoned.
(60) Provisional application No. 61/658,620, filed on Jun. 12, 2012.
(60) Provisional application No. 61/496,207, filed on Jun. 13, 2011.

(51) Int. Cl. G06F 17/30; G06Q 30/00

(52) U.S. Cl. 705/27.1; 707/827; 707/E17.01

(57) ABSTRACT

A computer based system for management of memorabilia including a processor coupled to memory and an input-output controller, a data store in communication with the processor, an input device coupled to the input-output controller and a display device coupled to the input-output controller. The memory includes at least one algorithm comprising an initial processing section configured to upload a plurality of images and audio files having a plurality of data file formats. The memory includes an organization and storage section configured to determine at least one location within the data store for storage of each of the plurality of images and audio files. The memory also includes an access and display section configured for at least one of creating, retrieving, viewing, moving, annotating and transmitting the images and audio files.

### CROSS REFERENCE TO RELATED APPLICATIONS

This application claims priority to U.S. Provisional Patent Application Ser. No. 61/496,207, filed Jun. 13, 2011 and U.S. Provisional Patent Application Ser. No. 61/658,620 filed Jun. 12, 2012, the entirety of which are incorporated by reference herein. The present application also claims priority to and is a continuation in part of copending and commonly owned U.S. patent application Ser. No. 12/975,928, filed Dec. 22, 2010 which is a continuation-in-part of U.S. patent application Ser. No. 11/867,745 filed Oct. 5, 2007, U.S. patent application Ser. No. 11/863,931 filed Sep. 28, 2007, U.S. patent application Ser. No. 11/854,577 filed Sep. 13, 2007, U.S. patent application Ser. No. 11/652,998 filed on Jan. 12, 2007, U.S. patent application Ser. No. 11/490,726 filed on Jul. 21, 2006, U.S. patent application Ser. No. 11/396,895 filed Apr. 3, 2006, and U.S. patent application Ser. No. 11/168,651, filed on Jun. 27, 2005 the contents of which are incorporated herein by reference in their entirety for all purposes.

### FIELD OF THE INVENTION

The present invention relates generally to a social media application for uploading, storing, organizing, enhancing, and displaying electronic representations of memorabilia and in particular to a computer based system which stores, organizes and displays the electronic representations of memorabilia, based on the type of memorabilia and input from the user, in electronic storage bins.

### BACKGROUND

Some people collect and accumulate memorabilia commemorating events that have had significance during their lifetime. Such memorabilia can include a child's artwork, photographs from a vacation, an acceptance letter to a college, a sound recording, a video recording, work from school projects, a child's report card, a copy of a winning lottery ticket and first imprints of a child's hands or feet.

Some people display the memorabilia on their refrigerator, for example, by securing the memorabilia to their refrigerator with one or more magnets. Over time, collection of the memorabilia can cause clutter. As a result of the clutter, some people store the memorabilia in boxes or bins and others discard it. The amount of memorabilia can become so extensive that it becomes difficult to access, sort through, view, share, listen to and/or display. For example, finding and flipping through hard copy photo albums and finding and playing home movies can be a cumbersome and time consuming task. In addition, capture of still images and video are typically done independent of one another and once created, cannot be easily altered or edited. As a result, the essence, meaning, story line or sense of the moment captured in a still image, video or audio recording is lost.

### SUMMARY

According to aspects illustrated herein, there is provided a computer based system for management of memorabilia including a processor coupled to memory and an input-output controller, a data store in communication with the processor, an input device coupled to the input-output controller and a display device coupled to the input-output controller. The memory includes at least one algorithm comprising an initial processing section configured to upload a plurality of images and audio files having a plurality of data file formats. The memory includes an organization and storage section configured to determine at least one location within the data store for storage of each of the plurality of images (e.g., still images, photos, artwork and videos) and audio files. The memory also includes an access and display section configured for at least one of creating, retrieving, viewing, moving, annotating and transmitting the images and audio files.

### BRIEF DESCRIPTION OF THE DRAWINGS

FIG. 1 is a simplified schematic block diagram of a computer based system for management of memorabilia, in accordance with one embodiment of the present invention;

FIG. 2 is a schematic illustration of the configuration of memorabilia management algorithms (MMA) of the computer based system for management of memorabilia of FIG. 1;

FIG. 3 is a schematic illustration of an initial processing section of the MMA of FIG. 2;

FIG. 4 is a schematic illustration of an access and display section of MMA of FIG. 2;

FIG. 5 is a representation of a graphical user interface depicting a Main or Navigation interface of the MMA of FIG. 2;

FIG. 6 is a representation of a graphical user interface of the MMA of FIG. 2 depicting adding an audio comment on an image;

FIG. 7 is a representation of a graphical user interface of the MMA of FIG. 2 depicting adding sound effects to an image;

FIG. 8 is a representation of a graphical user interface of the MMA of FIG. 2 depicting adding a doodle to an image;

FIG. 9 is a representation of a graphical user interface of the MMA of FIG. 2 depicting the process for uploading an image;

FIG. 10 is a representation of a graphical user interface of the MMA of FIG. 2 depicting creating and editing a data storage bin such as a STORYBOX™;

FIG. 11 is a representation of a graphical user interface of the MMA of FIG. 2 depicting a plurality of data storage bins such as a STORYBOXES™ for a particular user;

FIG. 12 is a representation of a graphical user interface of the MMA of FIG. 2 depicting a plurality of sports related images and groups of images in a sports data storage bin such as a STORYBOX™ of a particular user; and

FIG. 13 is a representation of a graphical user interface of the MMA of FIG. 2 depicting adding a video comment on an image.

### DETAILED DESCRIPTION

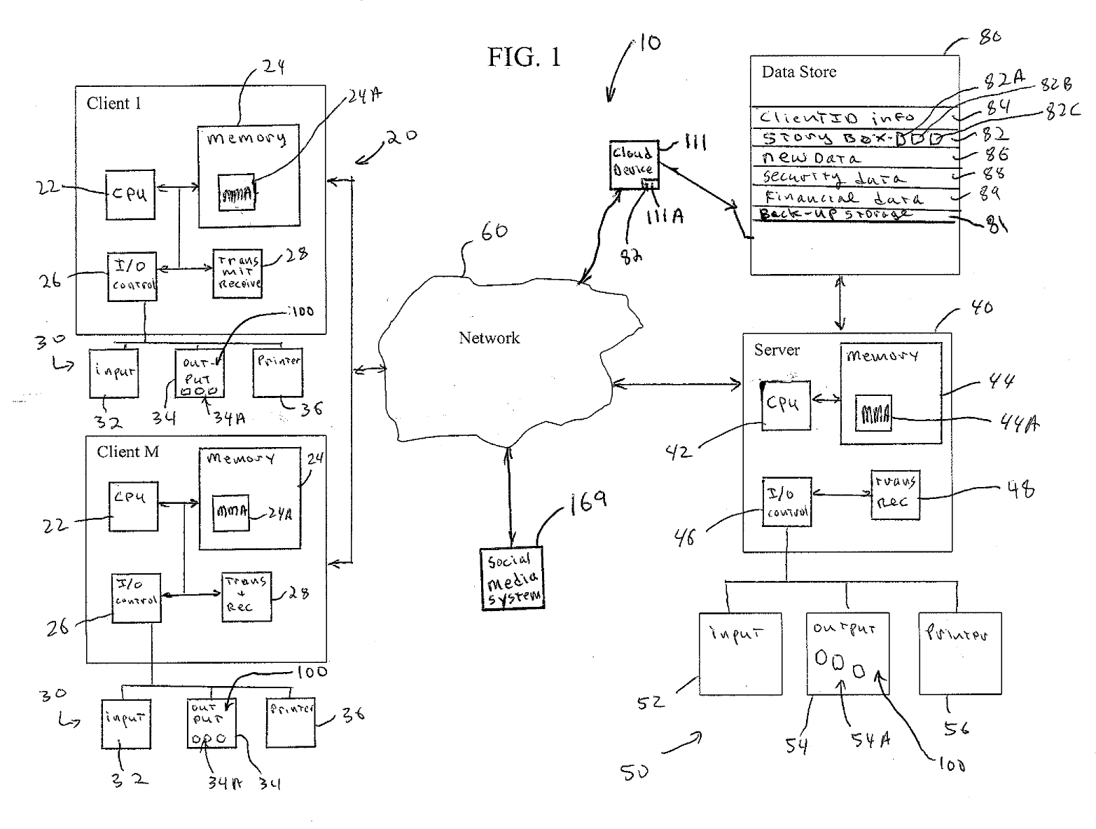

Referring to FIG. 1, the present invention provides a novel computer based system 10 for management of memorabilia (hereinafter the memorabilia management system 10), which stores, organizes, plays, broadcasts and displays images of the memorabilia such as but not limited to electronic representations of memorabilia, photographs, video recordings, audio recordings, any form, appearance, semblance, physical likeness or representation of a person, animal, or thing, photographed, drawn, painted, sculptured, or otherwise made visible; and stores, organizes, plays and broadcasts audio recordings, such as but not limited to audio files. The memorabilia includes items such as a child's artwork, photographs from a vacation, an acceptance letter to a college, a sound recording, a video recording, photographs, work from school projects, a child's report card, a copy of a winning lottery ticket and first imprints of a child's hands or feet.

In one embodiment, the memorabilia management system is a MOMENTAGE™ system which provides computer-implemented tools and methods, an application (“app”) based solution and a web site that gives users the ability to upload, store, view, organize, enhance, digitize, alter, comment upon, exchange, share and display memorabilia such as, but not limited to, photographs, artwork, video and audio works in a data store, such as, but not limited to a STORYBOX™ or STORYBIN™; and to print and generate two and three dimensional replicas, objects and designs of artwork and photographs, and to generate video and audio recordings and files. MOMENTAGE™ (U.S. Trademark Application Serial No. 85/642,332, filed Jun. 4, 2012); STORYBOX™ (U.S. Trademark Application Serial No. 85/642,362, filed Jun. 4, 2012); and STORYBIN™ (U.S. Trademark Application Serial No. 85/642,409, filed Jun. 4, 2012) are trademarks of Castineiras Companies, LLC of 270 Farmington Avenue, Farmington, Conn. 06032.

As described herein, the memorabilia management system 10 includes the following and other functions:

1. A single smartphone application (App) with an integrated computer interface that cooperate with one another to capture, immediately organize and display still images, audio and video recordings.

2. A memorabilia management system that is configured for on-line, point-of-capture, and remote creation of, uploading data to and access to a plurality of data storage bins, for example, STORYBOXES™ identified by icons and or indicia and that store electronic representations of images, audio and video in various segmentable compartments or categories, such as but not limited to holidays, baby, school, sports, art & crafts, vacations and new still images, audio and video.

3. A memorabilia management system that is configured to accept and integrate multiple formats of digitized still images, audio, video and still images with text, still image, video and audio annotations and comments.

4. Single point control, such as but not limited to “play button” initiation, selection and control of display and performance of still images, audio, video and still images with text, still image, video and audio annotations and comments.

5. Automatic updating, sorting and populating of the data stores and/or STORYBOXES™ triggered by the creation of a still image (e.g., taking of a photograph), uploading of a scanned image, recording of video images and/or recording of audio data or by user commands.

6. Selective transmission and sharing of electronic representations of images, audio, video and still images with text, still image, video and audio annotations and comments to and with a predetermined population.

7. Configured to communicate with and receive images, audio, video and still images with text, still image, video and audio annotations and comments from a plurality of predetermined sources, either simultaneously or sequentially.

8. Cloud based secure storage of images, audio, video and still images with text, still image, video and audio annotations and comments, for access from multiple locations at any time.

9. Packaging of the contents of or preselected portions of the data store and/or STORYBOXES™ for distribution and/or sale for retail purposes, fundraising activities and/or gifts.

10. The ability to transform all or portions of still images, audio recordings (e.g., digital electronic recordings) and video recordings (e.g., digital electronic recordings) into two or three dimensional objects and to distribute the same to predetermined recipients.

11. The ability to link to social media systems (e.g., FACEBOOK® and TWITTER®) to present a tiered pricing structure for access to and use of the services and products made available via the memorabilia management system 10.

12. The memorabilia management system 10 includes a capture verification module that is configured to verify the images, such as the still images, the audio recordings, and the video recordings are captured and stored in the storage bins (e.g., STORYBOXES™) and generates a delete permissive signal to prompt deletion of the still images, audio recordings, and video recordings from the device which captured them (e.g., a smart phone, an I-phone or a camera).

13. Provides image, video and audio capture, edit, annotation, storage, displaying and playing the images, the video recordings and the audio recordings in a single device, without the need for ancillary devices such as cameras, video recorders, photo albums, CDs, DVDs, CD and DVD players and the like.

14. Provides back-up storage capability in multiple remote locations to prevent loss of the images, the video recordings and the audio recordings, for example due to fire, theft or the like.

Referring to FIG. 1, the memorabilia management system 10 is configured to create, store, organize and display electronic representations of the memorabilia in a storage device, for example, STORYBOX™ or a virtual electronic museum, as described below. The memorabilia management system 10 includes a plurality of client devices (e.g., Client 1-M), shown generally at 20, operatively coupled to a server device 40 over a communication network 60 such as, for example, the Internet, an intranet, an extranet, or like distributed communication platform connecting computing devices over wired and/or wireless connections. In one embodiment, the STORYBOX™ is operable for viewing or listening via a single activation, for example via activation of a play button such as a click on button on a display screen, as described below. As is known to those skilled in the art, the client devices 20 and the server 40 may each include a CPU or processor 22 and 42, respectively, computer-readable medium or memory 24 and 44, respectively, an input-output controller 26 and 46 operatively coupled to input-output devices 30 and 50 including devices for facilitating input of data to the memorabilia management system 10 such as a keyboard, a mouse, light pen pointing device, document or card reader or scanner, or other input device 32 and 52, respectively, for displaying inputted and/or processed data and other information such as a pixel-oriented display devices 34 and 54, printers 36 and 56, or the like. The client devices 20 and the server 40 include communication means such as, for example, transceivers 28 and 48, for facilitating communication over the network 60. The processors 22 and 42 execute program instructions stored in memory such that users, customers and others operating individual ones of the client devices 20 communicate over the network 60 with other client devices 20 as well as other computing devices coupled to the network, such as the server device 40. As noted above, it should be appreciated that the client devices 20 and/or server 40 include, for example, a personal computer (PC), notebook computers, netbook computers, IPads®, Nooks™, workstations, laptops, tablet computer, personal digital assistant, pocket PC, Internet-enabled mobile radiotelephone, a smartphone, I-phone, pager or like portable computing devices.

As shown in FIG. 1, the server 40 is coupled to a data store 80. It should be appreciated that the data store 80 may be a relational data base, object oriented data base, a virtual electronic museum or other suitable data repository, as is known in the art. In one embodiment, the data store 80 includes one or more records, tables and/or data bases for storing information, data, programming parameters and/or variables employed within the memorabilia management system 10. For example, the data store 80 may include a plurality of STORYBOX™ 82 categories or names such as sports 82A, baby 82B and school 82C. In one embodiment, the data store 80 includes a section or bin for client identification information 84 (e.g., name, address, phone number, e-mail address, etc.), new data 86, security data 88 (e.g., passwords, user IDs, etc.) and financial data 89 (e.g., pricing, revenue, costs, billing and payment information). The data store 80 includes a first back-up storage section 81 for redundant storage of the images, the video recordings and the audio recordings. In one embodiment, the memorabilia management system 10 includes a cloud device 111 in communication with the network 60 and the data store 80. The cloud device 111 includes a second back-up storage section 111A for redundant storage of the images, the video recordings and the audio recordings in a STORYBOX™ 82.

In one embodiment, the server 40 of the memorabilia management system 10 is located at the cloud device 111 or site providing computer services to a plurality of users. In one embodiment, the server 40 and/or the data store 80 are cloud computing devices. The one or more client devices 20 include computing devices operated by the one or more users that are accessing the functions and features of the memorabilia management system 10 (described herein) in locations that are remote from the server 40, via the network 60.

The processors 22 and 42 execute computer-implemented steps and/or algorithms for memorabilia management 24A and 44A (hereinafter memorabilia management algorithms (MMA) 24A and 44A) stored in the memory 24 and 44 of the client devices 20 and the server 40, respectively. A person operating the memorabilia management system 10 may execute the MMA 24A and 44A, view still images, audio and video recordings outputted, for example, exhibited on the display device or display devices coupled to their computing devices (e.g., the display devices 34 and 54), and create and name STORYBOXES™, upload and comment on the still images, audio and video recordings and share the still images, audio and video recordings and comments annotated therewith with a plurality of predetermined entities, as described in further detail herein. It should be appreciated that the MMA 24A and 44A generally require manipulation of data in the form of electrical, magnetic and/or optical signals that may be inputted, stored, transferred, combined, compared, or otherwise manipulated to provide a desired result. For example, the MMA 24A and 44A may direct the processors 22 and 42, the input-output controllers 26 and 56, and/or the displays 34 and 54 to exhibit one or more user interfaces, e.g., application generated user interfaces, web pages, and the like, shown generally at 34A and 54A. Exemplary user interfaces 34A and 54A depicting the computer based system 10 and MMA 24A and 44A, are described below.

In one embodiment, the server 40 hosts the user interfaces 54A such as a home page and other web pages or a mobile phone App, that are requested by the user through designation of a Uniform Resource Locator (URL) identifying the web pages and providing access to the server 40 from other computing devices (e.g., the client devices 20) on the network 60. In one embodiment, access to the web pages 54A, server 40, the data store 80, selected portions thereof, and/or to selected services and functionality provided by the memorabilia management system 10, is restricted to registered or otherwise authorized users, administrators and others, as is described below. The client devices 20 execute programs such as, for example, web browser software to request, receive and process the web pages 54A from the server 40, for example, as web pages 34A exhibited on the display devices 34 of the client devices 20. The web pages 34A and 54A are generally written in a language that permits a graphical presentation of information (text, images, audio, video, and the like) to persons operating a computing device such as one of the client devices 20. Languages include, for example, the Hyper-Text Markup Language (HTML), Extensible Markup Language (XML) or another Standard Generalized Markup Language (SGML), as are generally known in the art.

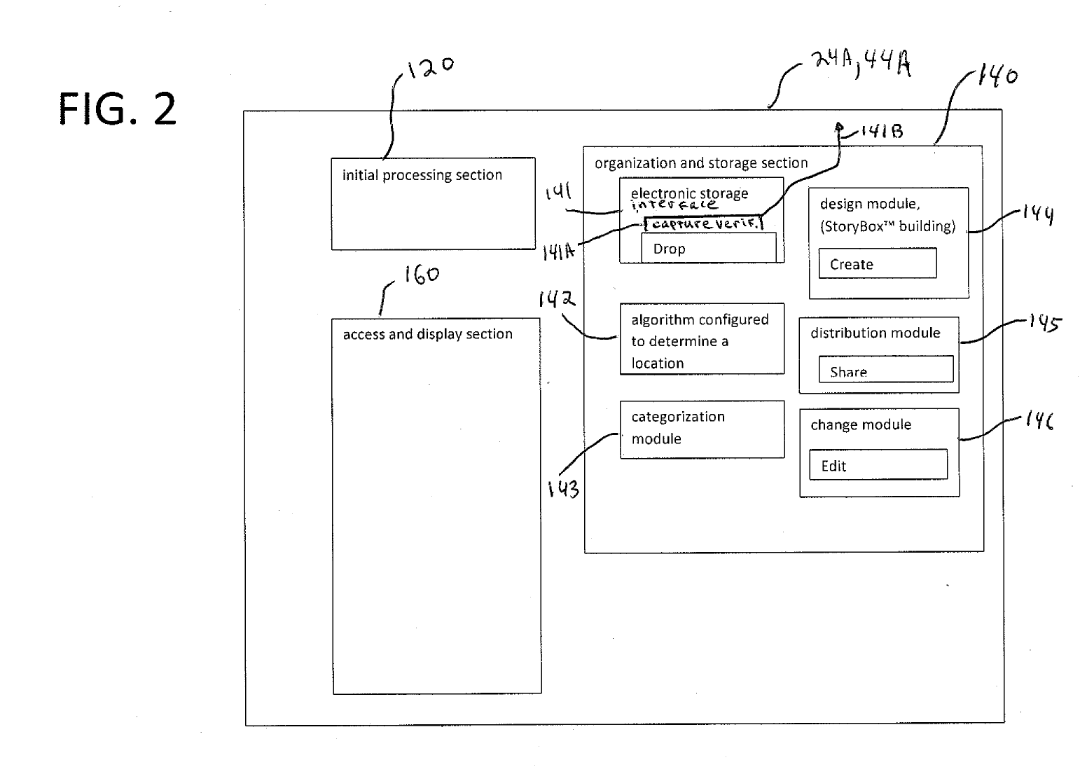

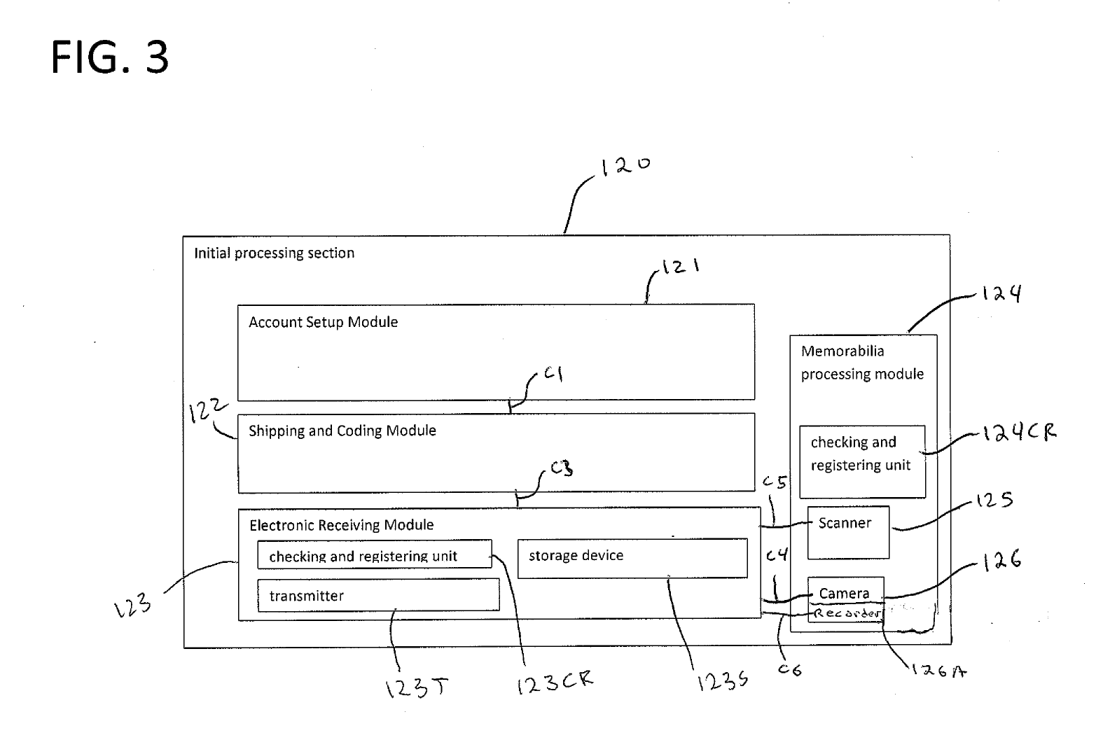

As shown in FIG. 2, the MMA 24A and 44A includes an initial processing section 120, an organization and storage section 140 and an access and display section 160. As shown in FIG. 3, the initial processing section 120 is configured to enable initial account setup and to receive memorabilia and electronically stored forms thereof. The initial processing section 120 includes an account setup module 121 which is configured to establish an account for each user, including establishing a username, password, data storage area, payment methods, e-mail communications and initial user preferences. The initial user preferences include, but are not limited to selection of a data storage size and format, display format and memorabilia transmission format. For example, the users have the option of selecting default formats or design and/or specify their own custom designed formats for data storage, data storage size and capacity expansion options, display and/or transmission of the electronic representation of the memorabilia. In one embodiment, the user is charged a fee for the custom designed data storage formats and/or the additional data storage capacity.

As illustrated in FIG. 3, the initial processing section 120 also includes a shipping and coding module 122 which is in communication with the account setup module 121 via a communication link C1 for transmitting the account information and permissive signals as detailed below. Communication between the shipping and coding module 122 and the users' client devices 20 is activated, after receiving a permissive signal from the account setup module 121, confirming the establishment of the respective user's account.

The shipping and coding module 122 generates coding information for use in transmitting, shipping, identifying and categorizing the memorabilia. The shipping and coding module 122 includes an algorithm for generating coding information, such as unique identification codes (e.g., alpha-numeric characters) that are used to identify each item of memorabilia. In one embodiment, the unique identification codes are automatically assigned according to characteristics of the memorabilia including memorabilia format (e.g., image, sound recording, video recording, etc.), date (e.g., creation date, submittal date, event date, etc.), event type (e.g., birthday, holiday, vacation, graduation, etc.), subject (e.g., daughter, son, pet, etc.) and/or other characteristics of the memorabilia, identified by the user. In one embodiment, the coding information is provided in a catalogue format. The shipping and coding module 122 is configured to generate the coding information in electronic format for use in submittal of the electronic representations of the memorabilia and/or in printable format (e.g., for printing on labels) for affixing to the memorabilia to be shipped to a receiving area.

As shown in FIG. 3, the initial processing section 120 also includes an electronic receiving module 123, which is in communication with the shipping and coding module 122 via a communications link C3 (e.g., an internet connection), for transmitting the coding information, the account information and the permissive signals as detailed below. Communication between the electronic receiving module 123 and the client devices 20 is activated, after receiving a permissive signal from the account setup module 121, confirming the establishment of the respective user's account.

The electronic receiving module 123 is configured to receive the electronic representations of the memorabilia, for example e-mail or electronic messages transmitted from the client devices 20. The electronic receiving module 123 includes a storage device 123S that automatically stores the e-mails, messages (e.g., text messages, voice messages, sound recordings, etc.) and attachments thereto (pictures, videos, sound recordings, text messages, etc.), received from each particular user in a unique user designated portion of the storage device 123S, such as a unique URL. The storage device 123S is configured to store the e-mails, messages and attachments until the user decides to catalogue or organize them or until the memorabilia management system 10 automatically organizes them, as described below.

The electronic receiving module 123 includes a checking and registering unit 123CR configured to check for and register the coding information associated with the electronic representations of the memorabilia.

The electronic receiving module 123 also includes a transmitter 123T for transmitting the electronic representations of the memorabilia to the access and display section 160 or a memorabilia processing module 124 (described below). The electronic receiving module 123 is also configured to optimize the electronic representations of the memorabilia, including cropping, rotating, straightening, sizing and framing the electronic representations of the memorabilia.

The initial processing section 120 also includes a memorabilia processing module 124 for processing memorabilia and the electronic representations of the memorabilia which do not include the coding information. The memorabilia processing module 124 is configured for creating an electronic representation of the memorabilia in a suitable format, such as a scanned image (e.g., a pdf or jpeg file), a text document (e.g., a pdf or MS Word doc file), a sound recording, a video recording and/or a photograph. For example, the memorabilia processing module 124 includes equipment for creating the electronic representations of the memorabilia from the memorabilia shipped to the receiving area. The equipment for creating the electronic representations includes, but is not limited to, a scanner 125, a camera 126 (e.g., still camera, video camera) and a recorder 126A (e.g., audio or video recorder). In addition, the memorabilia processing module 124 includes a checking and registering unit 124CR configured to check for and register the coding information associated with the memorabilia. The memorabilia processing module 124 is in communication with the shipping and coding module 122 for adding the coding information to the memorabilia if required.

In one embodiment, the electronic receiving module 123 is in communication with the camera 126 via the communication link C4, the scanner 125 via the communications link C5 and the recorder 126A via the communications link C6. The electronic receiving module 123 is configured to upload a plurality of images and audio files from the camera 126, the scanner 125 and the recorder 126A coincident with a point-of-capture of the images and audio files by the camera 126, the scanner 125 and/or the recorder 126A. The organization and storage section 140 and in particular the algorithm 142 configured to determine a location of the images, video recordings, audio recordings and audio files is configured determine at least one location within the data store 80 for storage of each of the plurality of images and audio files coincident with the point-of-capture of the images and audio files by the by the camera 126, the scanner 125 and/or the recorder 126A. Thus the possibility for misplacing, misclassifying, loosing or erasing the plurality of images and audio files in the camera 126, the scanner 125 and/or the recorder 126A or on other intermediate storage medium such as flash drives, memory cards, CD's and DVDs is minimized or eliminated.

Referring back to FIG. 2, the organization and storage section 140 includes an electronic storage interface algorithm 141 for communicating with the data store 80 in which the electronic representations of the memorabilia is stored. The organization and storage section 140 includes an algorithm 142 configured to determine a location (e.g., a virtual electronic wall, bin, STORYBOX™, floor and/or room) within the data store 80 to store each of the electronic representations of the memorabilia. The organization and storage section 140 includes a categorization module 143 which includes an algorithm that is configured to identify common attributes of the electronic representations of the memorabilia, based upon an assessment of the characteristics of the memorabilia and identifies groups and sub-groups of the electronic representations of the memorabilia. For example, the algorithm identifies groups such as family, which can include sub-groups of vacation, school and birthday related memorabilia. The electronic storage interface algorithm 141 includes a capture verification module 141A that is configured to verify the still images, audio recordings, and video recordings are captured and stored in the storage bins (e.g., STORYBOXES™) and to generate a delete permissive signal 141B to prompt deletion of the images, audio recordings, and video recordings from the client device (20) (e.g., a smart phone, an I-phone or a camera), the camera 126, the recorder 126A or the scanner 125 which captured them after verification of the storage of the images, audio recordings, and video recordings in the STORYBOXES™ 82.

Referring to FIG. 2, the organization and storage section 140 includes a design module 144 which includes algorithms for the creation, formatting, security coding and naming of storage bins, such as for example STORYBOXES™. The design module 144 includes a catalog of standard storage formats, for example a plurality of graphical roadmaps of various virtual electronic museums, storage bins or STORYBOXES™. The catalog of standard storage formats includes identification of electronic museum rooms and indicia such as icons or drop down menus which indicate the contents of each museum room. The organization and storage section 140 also includes a distribution module 145 which automatically places the electronic representations of the memorabilia in one or more of the electronic museum rooms, storage bins, STORYBOXES™ 82 or walls, based on predetermined criteria and is configured to share and transmit still images, audio and video recordings to predetermined users upon receipt of commands and automatically in response to predetermined criteria (e.g., a list of e-mail addresses and/or names of people). The organization and storage section 140 also includes a change module 146 which enables changing, editing, renaming or adding electronic museum rooms, storage bins or STORYBOXES™ 82 in which the electronic representations of the memorabilia is stored. Such changing of or adding museum rooms, storage bins or STORYBOXES™ 82 may result in a fee charged to the user. The change module 146 is also configured to set the frequency, time and date that the electronic representations of the memorabilia will be displayed. For example, certain electronic representations of the memorabilia can be selected for continuous or periodic display during a particular holiday season.

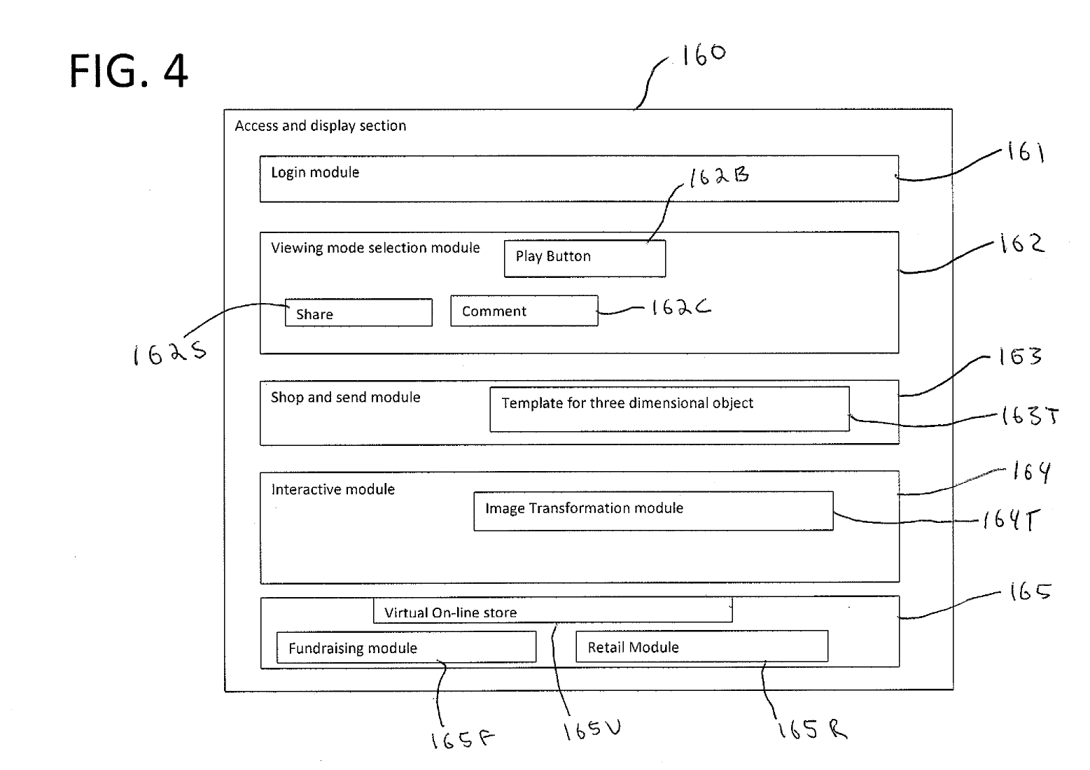

Referring to FIG. 4, the access and display section 160 is configured for retrieving, creating, viewing, moving and transmitting the electronic representations of the memorabilia. For example, the electronic representations of the memorabilia are retrieved from, created, moved and viewed in, and transmitted to and from the electronic storage device 141 (e.g., the virtual electronic museum, the storage bin or the STORYBOX™ 82).

The access and display section 160 includes a login module 161, a viewing mode selection module 162, a shop and send module 163 and an interactive module 164 interconnected with one another via suitable communication links. The login module 161 is configured to request the users' username and password, compare the username and password to those established in the initial processing section 120 and authorizing access to portions of the memorabilia management system 10. For example, the login module 161 authorizes access to the viewing mode selection module 162, the shop and send module 163 and the interactive module 164. In one embodiment, the access and display section includes and a fundraising module 165. The login module also can authorize access to the fundraising module 165.

The viewing mode selection module 162 includes a browse setting which allows the user to select and view the electronic representations of the memorabilia at the discretion of the user. The viewing mode selection module 162 also includes an automatic setting which triggers a random or predetermined display of the electronic representations of the memorabilia. The viewing mode selection module 162 also includes a user preference selector (not shown) which enables the user to select viewing preferences and commands such as, but not limited to adjusting contrast, color, volume, size and orientation; adjusting special effects, such as animation and three dimensional effects; printing; e-mailing; and playing, pausing, fast forwarding and reversing videos, of the electronic representations of the memorabilia. The viewing mode selection module 162 includes a play button 162B which is configured to be activated by a user to initiate display and performance of still images, audio, video and combinations thereof and contents of the data store 80 (e.g., one or more STORYBOXES™ 82) in chronological sequence or a predetermined sequence, speed, volume, order and direction, in one or more steps (e.g., viewing sequences or sweeps). The viewing mode selection module 162 includes a share button 162S which is configured to be activated by the user to share and transmit still images, audio, video and combinations thereof and contents of the data store 80 (e.g., one or more STORYBOXES™ 82) to one or more predetermined users, addresses, FACEBOOK® friends or the like. The viewing mode selection module 162 includes a comment button 162C which is configured to be activated by a user to comment on or add audio, video, text, doodles and/or still images to other add audio, video, text, doodles and/or still images.

The shop and send module 163 includes a catalog and order processing section (not shown) which is configured to enable the user to select and purchase one or more of the electronic representations of the memorabilia, coloring books (e.g., three dimensional coloring books), access to electronic coloring books (e.g., electronic three dimensional coloring books, on-line art tools and three dimensional illustration software), three dimensional renditions of the electronic representations of the memorabilia (e.g., three dimensional figures created by a three dimensional printer), accessories (e.g., microphones, recording devices, voice recording software and art forms) and custom designed postage (e.g., Artstamps@https://www.artstamps.com/). In one embodiment, the shop and send module 163 includes a template section 163T for ordering and purchasing templates, for example, models, body parts, structural components and patterns for creating three dimensional objects, such as three dimensional renditions of memorabilia and figurines. The users can assemble, paint, dress or otherwise decorate the three dimensional objects.

The interactive module 164 includes a module for initiating and conducting contests, including submitting and tallying votes, collecting contest fees, announcing contest winners and awarding prizes, for example monetary awards. The interactive module 164 also includes a module for enabling authorized users to comment on and or annotate the electronic representations of the memorabilia. The interactive module 164 also includes a module for the online electronic creation of and/or remote submittal of memorabilia, for example client devices 20. In addition, the interactive module 164 is configured for users to create electronic three dimensional images using the three dimensional illustration software. The interactive module 164 is in communication with the shop and send module 163 to enable the user to save the three dimensional images in electronic format in the viewing and selection module 162. In one embodiment, the interactive module 164 is in communication with the shop and send module 163 to enable the user to purchase, create (e.g., via a printer configured to create three dimensional objects) and send three dimensional renditions of the three dimensional images.

For example, the user can use on-line art tools for creating original or custom artwork via a computer. The user can access a website by entering an access code to gain access to the website. The website includes software programs that simulate, drive and allow the user to manipulate icons of tools, artforms and/or materials for creating the original or custom artwork on-line. The on-line tools, the artforms and/or the materials for creating the original or custom artwork on-line include, but are not limited to, on-line forms of paints, paint brushes, crayons, markers, color palettes (e.g., a display of a complete range of colors made available by a computer graphics card, from which the user or a computer program may choose those to be displayed), shapes, graphics and images. The website includes a catalog of the on-line tools, the artforms and/or the materials for creating the original or custom artwork, for selection by the user.

In one embodiment, the on-line art tools include software for transforming the artwork or images into a three dimensional object or body or into an electronic image having a three dimensional appearance, such as that disclosed in commonly owned U.S. patent application Ser. No. 13/409,781, entitled System and Method for Transformation and Animation of Images, filed Mar. 1, 2012, which is herein incorporated by reference in its entirety. In one embodiment the interactive module 164 includes, a transformation subsection 164T for transforming the artwork and images into a three dimensional physical body or object. In one embodiment, the transformation subsection 164T is a printer which creates a three dimensional object based on and representative of the artwork and/or image. In addition, the transformation subsection 164T includes, for example a device for creating a digital rendering of the modified image with three dimensional appearances. The transformation section 164A is configured to enable the user to select images of such as, but not limited to, human or animal body parts (e.g., arms, legs, necks and torsos), structural components (frames, ship hulls, windows, doors and chimneys) and assembly them to form a three dimensional body or structure. In addition, the transformation section 164A is configured to enable the user to select clothing and dress or undress the three dimensional body. The three-dimensional bodies or structures can be used as memorabilia, toys, figurines, promotional material and/or a collectible item. In one embodiment, the transformation section 164A is configured to create audio and video recordings, transmit the recordings via electronic data transmission (e.g., e-mail, mobile phone), copy the audio and video recordings on suitable electronic media (e.g., DVDs, CDs, flash drives, etc.) and create website links for the audio and video recordings accessible through the internet.

In one embodiment, the fundraising module 165 includes a virtual on-line store 65V, which can be used for distributing, trading, collecting, buying and/or selling memorabilia, including but not limited to the three dimensional objects and the electronic images having a three dimensional appearance. The virtual on-line store 165V includes software (not shown) configured to establish a store name, domain name and URL, add serial numbers to memorabilia, control the number of and time at which the memorabilia are available for sale and collect and distribute proceeds from such sales to a plurality of entities. The virtual on-line store 165V is in communication with one or more websites (e.g., www.artstamps.com) to leverage sales of the memorabilia.

The interactive module 164 also includes a module for users to request and pay for elaborate design of a personal electronic museum or STORYBOX™ 82 (e.g., multiple architectural designs, colors, patterns, floor plans, number of floors, landscape, internal decorations, etc,) expanded electronic storage and downloading specialized online art tools.

In one embodiment, the financial module 165 which includes a fundraising module 165F and a retail module 165R. The fundraising module 165F configured to interact with non-profit organizations or other entities for the management and generation of income. In one embodiment, the fundraising module 165F includes an advertising module for linking to and/or creating advertising for fundraising or other purposes. For example, the fund raising module 65 includes fundraising systems and method such as, but not limited to, those defined in the copending and commonly owned U.S. patent application Ser. No. 12/975,928, filed Dec. 22, 2010.

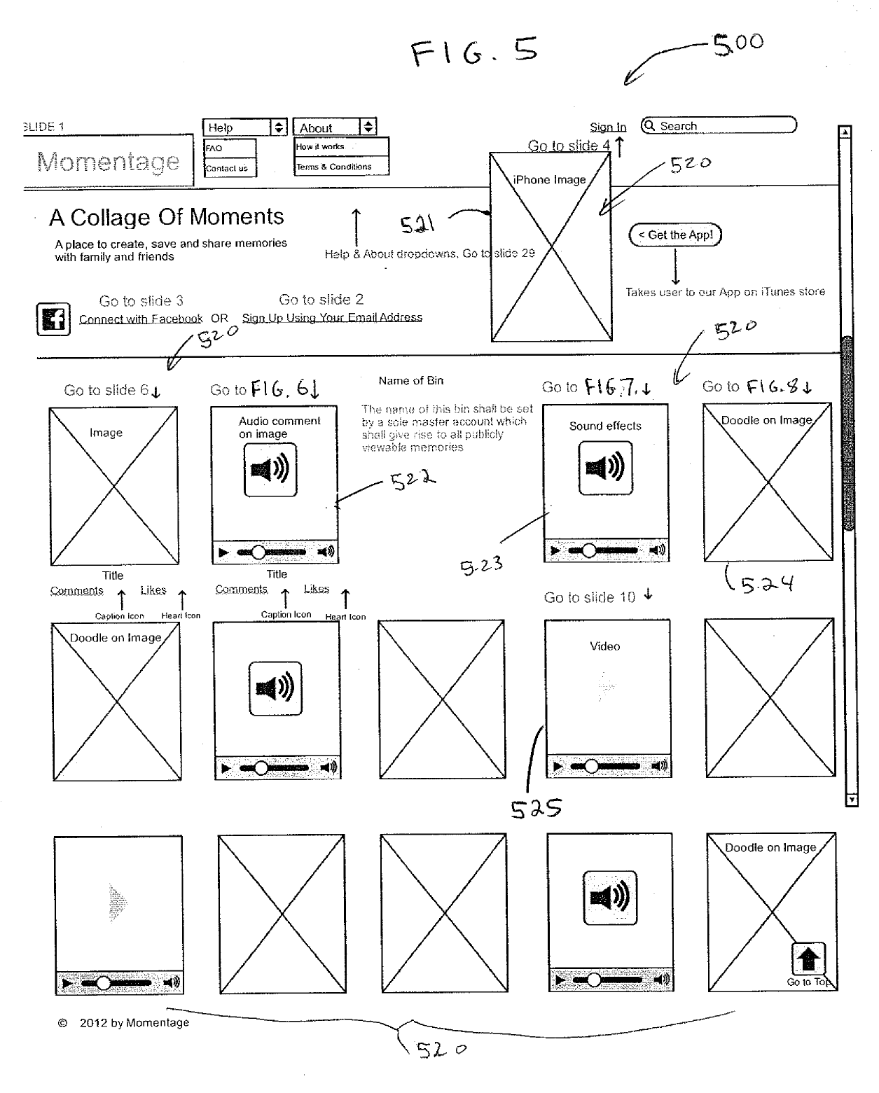

The retail module 165R is configured to establish a portal or website for on-line retail transactions, of memorabilia management services and products stemming therefrom. For example, all or portions of the data store 80 or STORYBOXES™ 82 may be purchased, sold or traded or sent as gifts via the retail module 165R. As illustrated in FIG. 1, the MMA 24A and 44A includes an MMA log-in user interface (UI) 100. The MMA log-in UI 100 is initially exhibited on the display devices 34 and/or 54 of one the client devices 20 and/or server 40 (e.g., as one of the user interfaces 34A and 54A). As can be appreciated, the memorabilia management system 10 is accessible by authorized persons referred to as users. In one embodiment, it is envisioned that users of the memorabilia management system 10 include, but are not limited to, subscribers and members of the memorabilia management system 10. Each user is provided a user identification (e.g., user ID) and password that is inputted to the MMA log-in UI 200, via a login page navigatable from a home page 200 (FIG. 5) of an MMA website to invoke memorabilia management system operations. As described herein, the subscribers and members of the memorabilia management system 10 employ the memorabilia management system 10 to monitor and manage their activities relating to the uploading, editing, commenting on, sharing, displaying, performing and transmitting still images, audio, video recordings and combinations thereof. Memorabilia management system administrators may perform memorabilia management system maintenance such as, for example, add, change and delete subscribers or members from memorabilia management system 10, run summary and statistical reports of system utilization and the like.

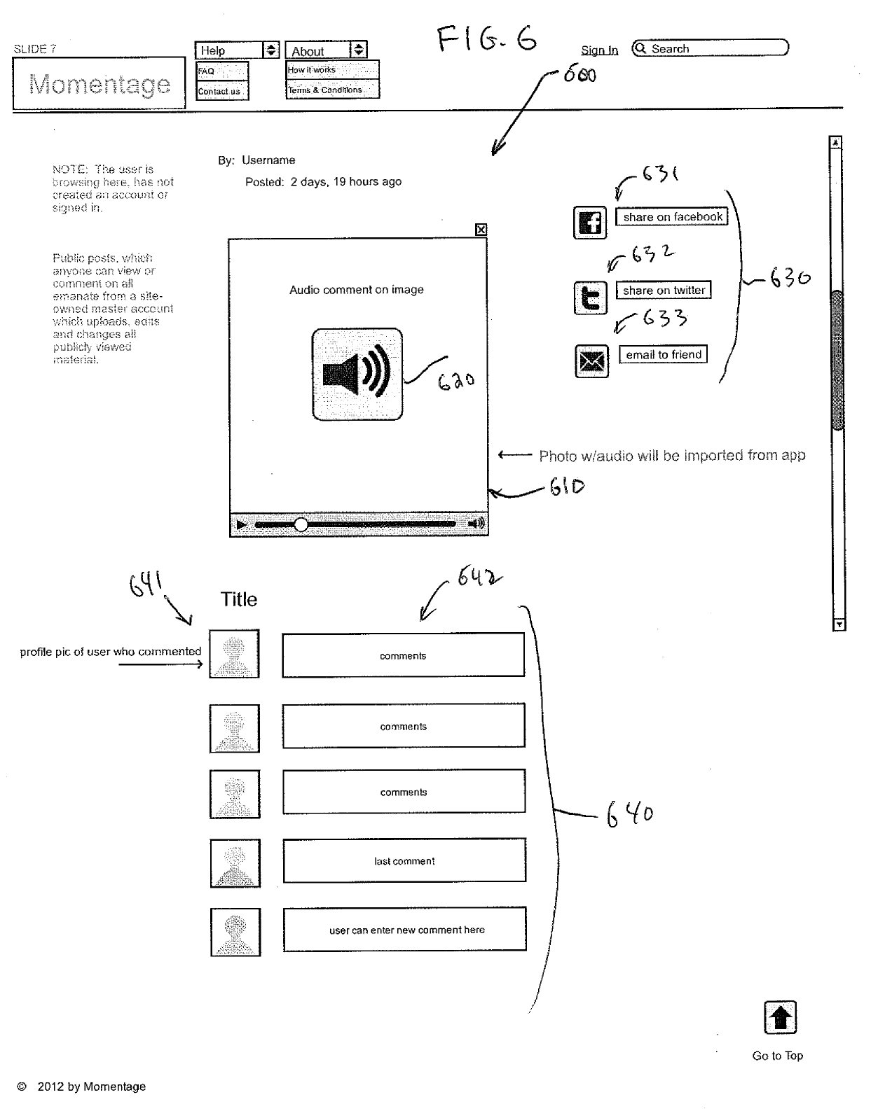

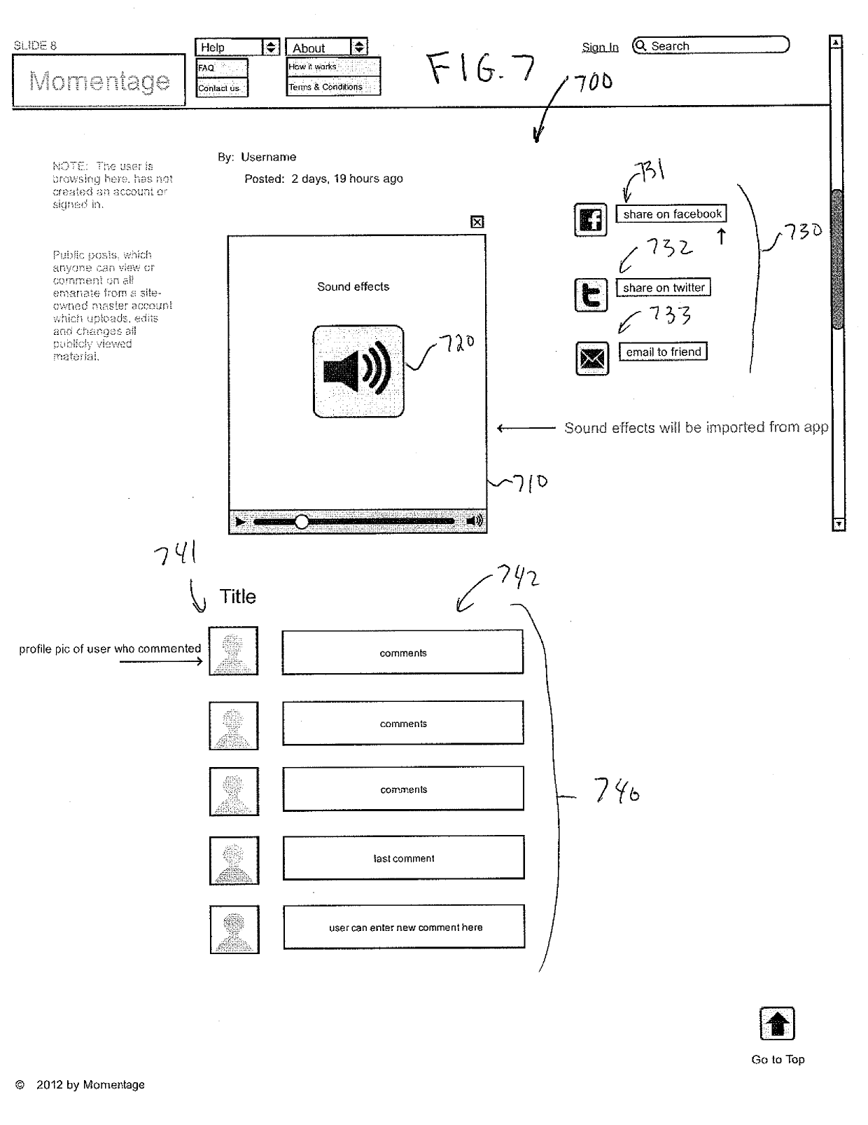

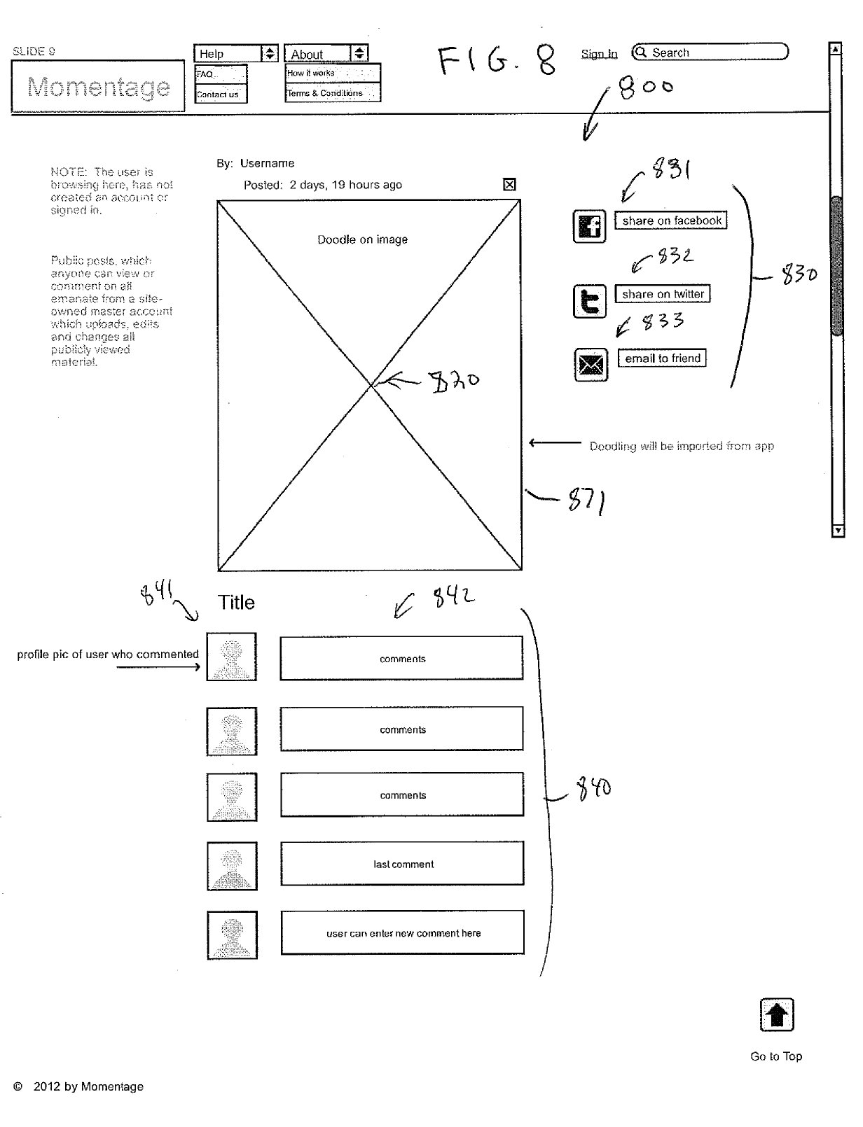

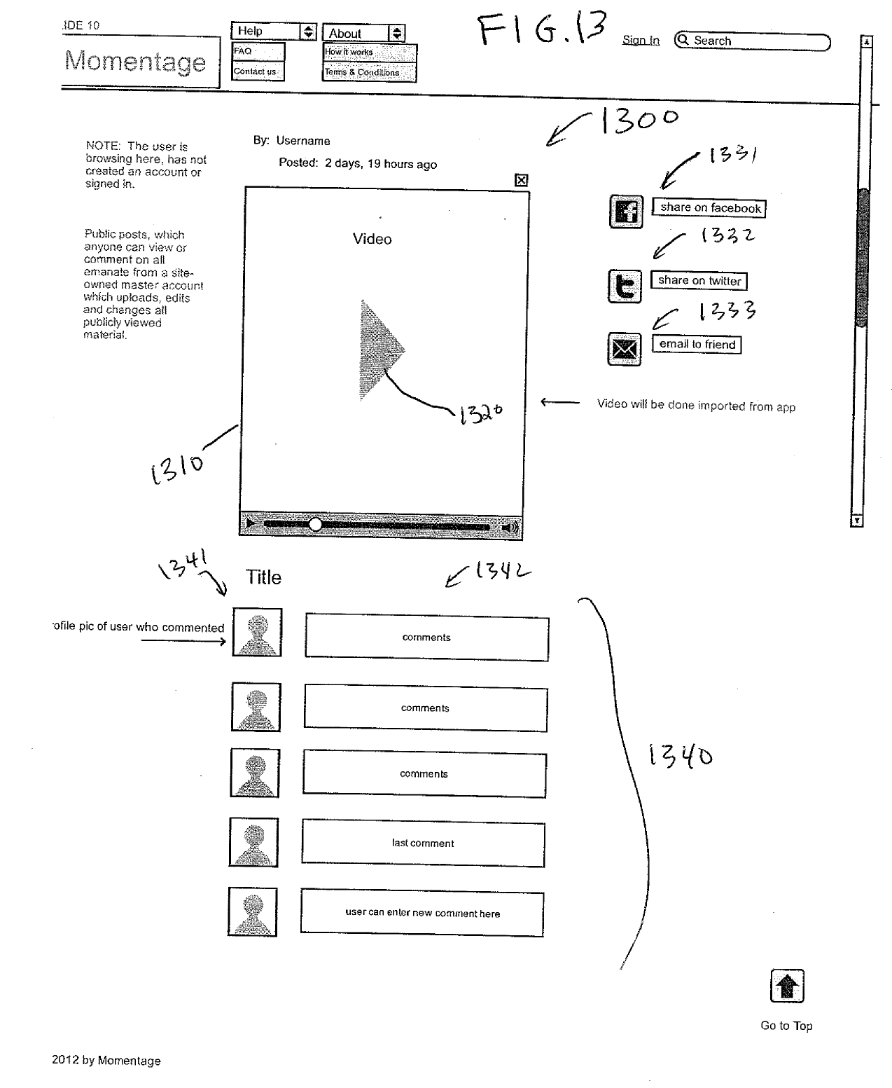

Once the log-in process is complete, users are directed to one or more user interfaces of the memorabilia management system 10. For example, FIG. 5 depicts the home navigation page “dashboard” 500 which is presented to a user on one of the client devices 20 and/or the server 40. The dashboard 500 is presented on a webpage accessible via the internet. In one embodiment, the dashboard 500 is accessible and fully operational via an Application (i.e., App. or software application) installed on a mobile telephone such as an I-phone or smart phone. The dashboard 500 includes a plurality of access controls collectively referred to with the element number 520 that, when selected, invoke a more detailed input, process, navigation to another web page or control user interfaces for initiating one or more features and functions of the memorabilia management system 10 as described herein. For example, the access controls 500 include: 1) login navigation button 521; 2) an audio comment on image navigation button 522; 3) a sound effects navigation button 523; 4) a doodle on image navigation button 524 and 5) a video effects navigation button 525. The login navigation button 521 links a user to a login page for entry of a user identification and password to gain access to the memorabilia management system 10, a camera, the cloud storage device 111, a smart phone, an I-phone, the client device 20 or the server 40 for automatically or manually uploading still images (e.g., photographs, digitized artwork, etc.), audio and video recordings. The audio comment on image navigation button 522 links a user to an audio comment on image webpage 600 as shown in FIG. 6, and described further below. The sound effects navigation button 523 links a user to a sounds effects webpage 700 as shown in FIG. 7, and described further below. The doodle on image navigation button 524 links the user to a doodle on image webpage 800 as shown in FIG. 8, and described further below. The video effects navigation button 525 links the user to a video effects webpage 1300 as shown in FIG. 13, and described further below.

As shown in FIGS. 6-8, the still images (e.g., photographs, digitized artwork, etc.), audio and video recordings may be modified at the webpages 600, 700 and 800. Once entered and/or modified, the still images (e.g., photographs, digitized artwork, etc.), audio and video recordings are stored by the memorabilia management system 10 such as, for example, as records within the data store 80 or STORYBOX™ 82.

Referring to FIG. 6, the audio comment on image webpage 600 includes a still image window 610 in which an image, such as a photograph, is uploaded or imported via an MMA App from the client device 20 or the server 40, and displayed in the window 610. The audio comment on image webpage 600 includes a sound recording button 620 which is activatable by clicking thereon to record sounds such as voice messages and music at the discretion of the user to annotate and memorialize the still image with the sound recording. The audio comment on image webpage 600 includes activation buttons 630 (e.g., a Facebook® button 631, a Twitter® button 632 and an e-mail button 633), for sharing the still image with or without the sound recordings and for authorizing and granting private and/or public access for others to comment on and record sounds relating and electronically tagged and linked to the still image. The audio comment on image webpage 600 includes a comment log 640 that identifies users who commented on (e.g., added sound recordings to) one or more particular still images. The comment log 640 includes a profile information section 641 for providing and displaying information about the person who commented on the still image. The comment log 640 also includes buttons 642 which link the user to and activate the sound recording and or comment made by the persons commenting on the still image.

Referring to FIG. 7, the sound effects webpage 700 includes a still image window 710 in which an image, such as a photograph, is uploaded or imported via an MMA App from the client device 20 or the server 40, and displayed in the window 710. The sound effects webpage 700 includes a sound recording button 720 which is activatable by clicking thereon to record sounds such as prerecorded sounds accessible from a electronic library, database or pull-down menu and include sounds such as but not limited to music, chimes, alarms, horns, buzzers and the like at the discretion of the user to annotate and memorialize the still image with the sound recording. The sound effects webpage 700 includes activation buttons 730 (e.g., a Facebook® button 731, a Twitter® button 732 and an e-mail button 733), for sharing the still image with or without the sound recordings and for authorizing and granting private and/or public access for others to comment on and record sounds relating and electronically tagged and linked to the still image. The sound effects webpage 700 includes a comment log 740 that identifies users who commented on (e.g., added sound recordings to) one or more particular still images. The comment log 740 includes a profile information section 741 for providing and displaying information about the person who commented on the still image. The comment log 740 also includes buttons 742 which link the user to and activate the sound recording and or comment made by the persons commenting on the still image.

Referring to FIG. 8, the doodle on image webpage 800 includes a still image window 810 in which an image, such as a photograph, is uploaded or imported via an MMA App from the client device 20 or the server 40, and displayed in the window 810. The doodle on image webpage 800 includes a doodle on image button 820 which is activatable by clicking thereon to alter the image by electronically doodling on the still image (e.g., drawing eyebrows, facial hair, a tail or large ears on the still image, adding a user's personal signature to the still image, handwriting notes or marks on the still image) at the discretion of the user to annotate and memorialize the still image with the. The electronic doodling on the still image includes use of electronic pens and paint brushes and on-line tools, artforms and/or the materials for creating the original or custom artwork or text such as, but are not limited to, on-line forms of paints, paint brushes, crayons, markers, color palettes (e.g., a display of a complete range of colors made available by a computer graphics card, from which the user or a computer program may choose those to be displayed), shapes, graphics and images, as described in commonly owned and copending U.S. patent application Ser. No. 12/975,928, filed Dec. 22, 2010 and its priority applications as described in the Cross Reference to Related Applications section of the present application. The doodle on image webpage 800 includes activation buttons 830 (e.g., a Facebook® button 831, a Twitter® button 832 and an e-mail button 833), for sharing the still image with or without the doodles and for authorizing and granting private and/or public access for others to comment on and create doodles on the still images which are electronically tagged and linked to the still image. The doodle on image webpage 800 includes a comment log 840 that identifies users who commented on (e.g., doodled on) one or more particular still images. The comment log 840 includes a profile information section 841 for providing and displaying information about the person who commented on (e.g., doodled on) the still image. The comment log 840 also includes buttons 842 which link the user to and activate the doodled on image and or comment made by the persons commenting on the still image.

Referring to FIG. 13, the video effects webpage 1300 includes a still image window 1310 in which an image, such as a photograph, is uploaded or imported via an MMA App from the client device 20 or the server 40, and displayed in the window 1310. The video effects webpage 1300 includes a video recording button 1320 which is activatable by clicking thereon to record videos such as prerecorded videos accessible from an electronic library, database or pull-down menu and includes videos such as, but not limited to, movies, home video clips, I-phone video clips, television news recordings and the like, at the discretion of the user to annotate and memorialize the still image with the video recording. The video effects webpage 1300 includes activation buttons 1330 (e.g., a Facebook® button 1331, a Twitter® button 1332 and an e-mail button 1333), for sharing the still image with or without the video recordings and for authorizing and granting private and/or public access for others to comment on and record video relating and electronically tagged and linked to the still image. The video effects webpage 1300 includes a comment log 1340 that identifies users who commented on (e.g., added video recordings to) one or more particular still images. The comment log 1340 includes a profile information section 1341 for providing and displaying information about the person who commented on the still image. The comment log 1340 also includes buttons 1342 which link the user to and activate the video recording and or comment made by the persons commenting on the still image.

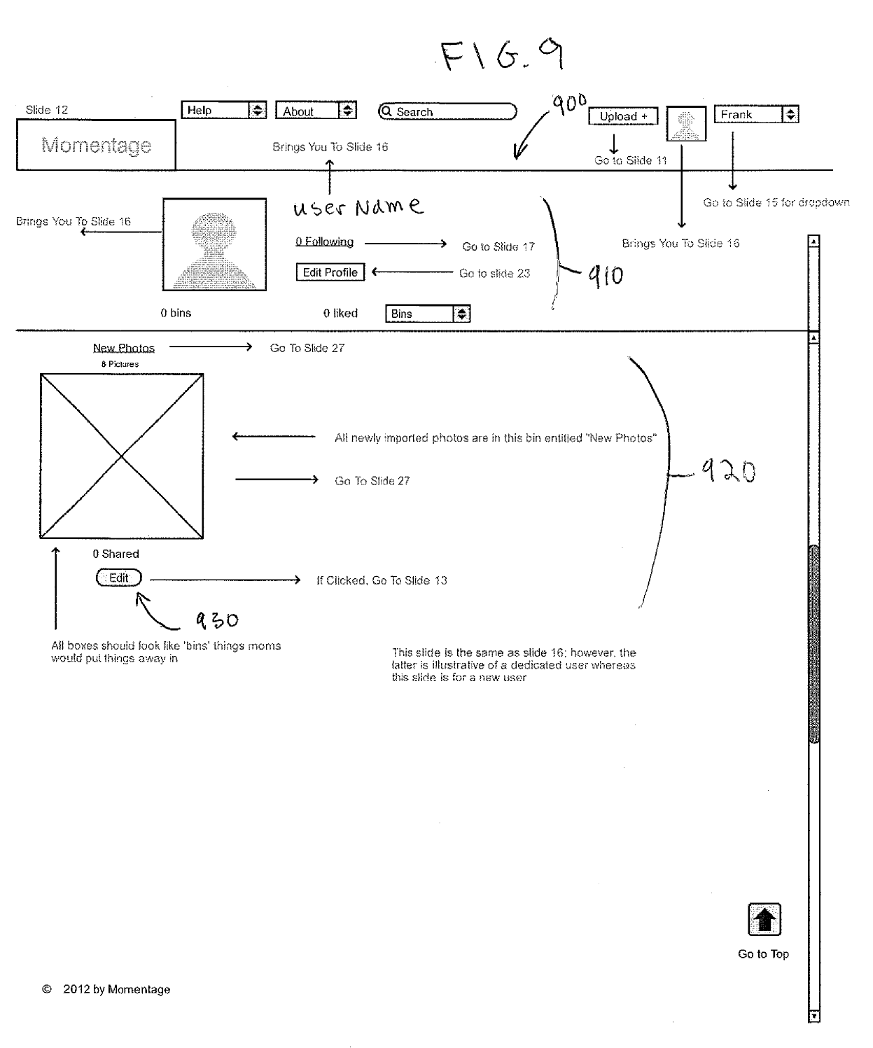

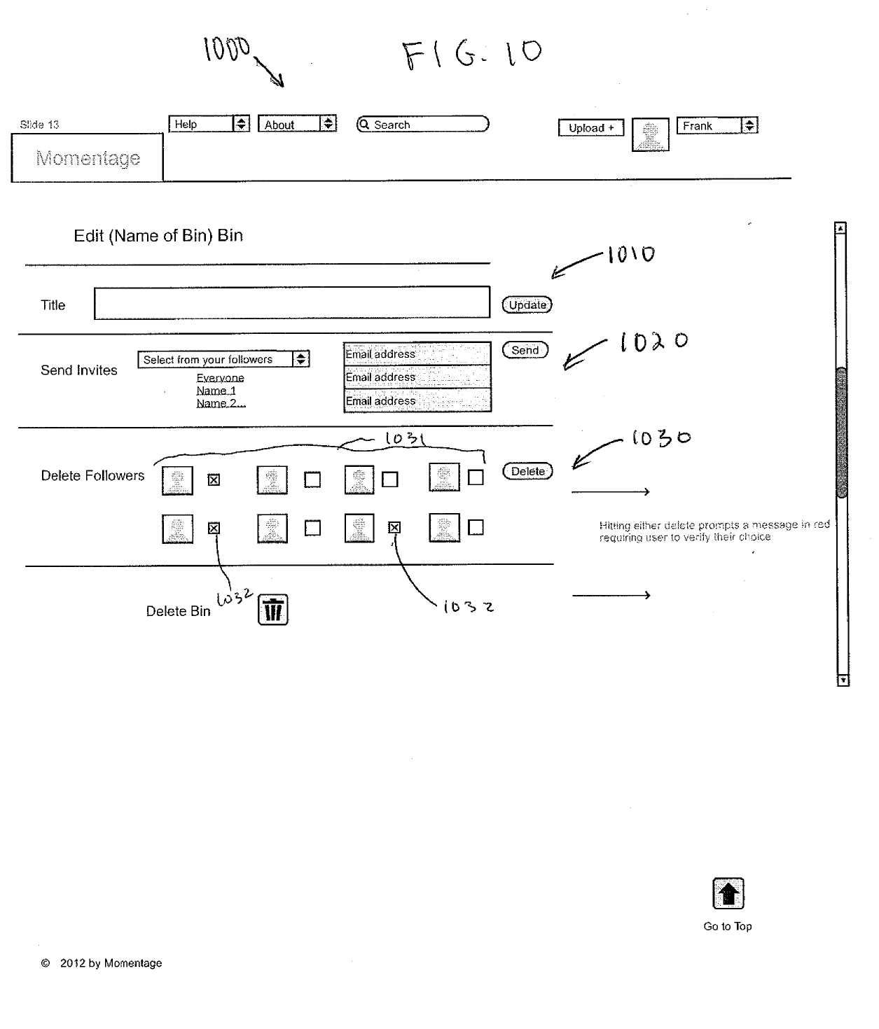

Referring to FIG. 9, an image uploading web page 900 includes a user profile section 910 which is configured to enable users to input and edit their profile information including access levels for viewers and establishing share lists. The image uploading web page 900 also includes a new image uploading section 920 which includes links to sources of photos, videos, and audio recordings and a link to the data store 80. The image uploading web page 900 further includes an edit button 930 which links the user to a create and edit web page 1000 (see FIG. 10) for creating, naming and editing storage bins such as the STORYBOXES™ 82.

Referring to FIG. 10, the create and edit web page 1000 includes a first field 1010 for assigning a name or title to the STORYBOXES™ 82, for example, sports, baby, school, etc. The create and edit web page 1000 also includes a second field 1020 for identifying and selecting invitees and inputting addresses of invitees (e.g., e-mail addresses). The create and edit web page 1000 further includes a follower status and edit section 1030 which includes a list of followers 1031 and buttons 1032 for deleting followers (e.g., terminating followers access to the STORYBOXES™ 82).

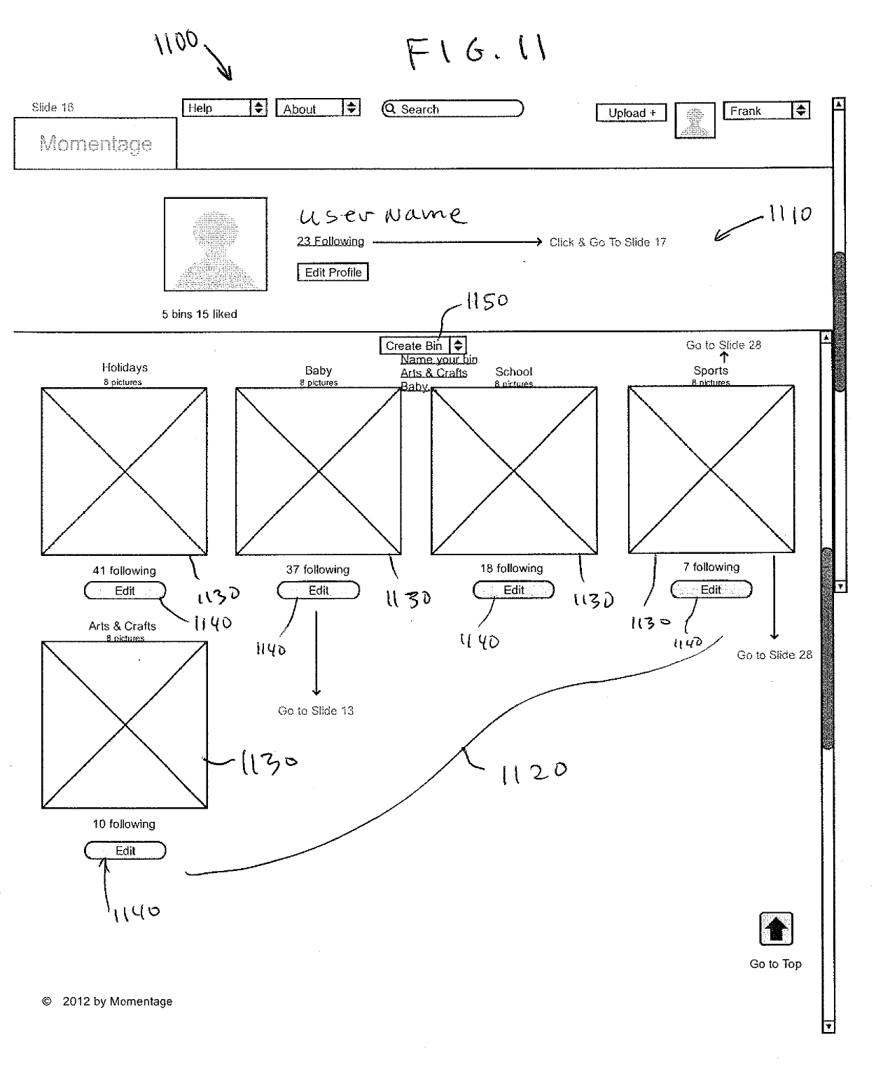

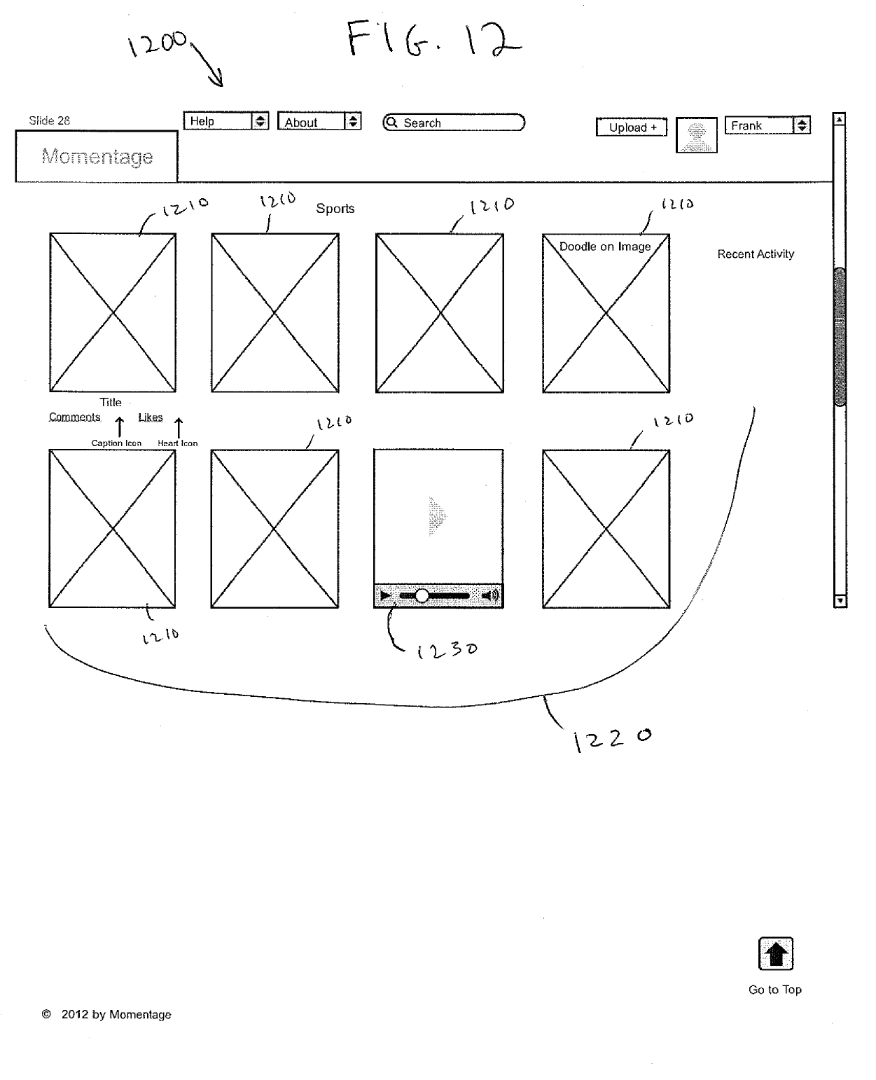

Referring to FIG. 11, a STORYBOX™ 82 summary web page 1100 includes a user profile section 1110 which is configured to enable users to input and edit their profile information including access levels for viewers and establishing share lists. The STORYBOX™ 82 summary web page 1100 includes a storage bin management section 1120 which includes a plurality of icons 1130 having indicia relating to the category of the contents of the respective bin or STORYBOX™ 82. Each of the icons 1130 is operative as a clickable button that causes the contents (e.g., still images, video and audio recordings) in the bin (e.g., the STORYBOX™ 82) to be downloaded from the data store 80 and displayed, for example in a particular bin or STORYBOX™ 82 webpage 1200 as shown in FIG. 12. The storage bin management section 1120 includes edit buttons 1140 for editing the content, name, icons 1130. The storage bin management section 1120 also includes a button 1150 which is operative to link to the create and edit web page 1000 illustrated in FIG. 10. As shown in FIG. 12, the STORYBOX™ 82 webpage 1200 includes a storage bin management section 1220 which includes a plurality of icons 1210 which are operative as links to download and display still images, video and audio recordings from the data store 80. The storage bin management section 1220 also includes a play button 1230 which is configured to download and display the still images, video and audio recordings from the data store 80 in chronological order or in a predetermined order upon the demand of the user or automatically based upon a trigger (e.g., at date and time, or upon detection of one or more predetermined names or addresses of a visitor or follower).

In one embodiment, the MMA 24A, 44A is in communication with a social media system (e.g., FACEBOOK®, TWITTER®) via the network 60. For example, the MMA 24A, 44A and the social media system 169 exchange information, the images, video recordings, audio recordings via the network 60. In one embodiment, the retail module 165R is in communication with the social media system (e.g., FACEBOOK®, TWITTER®) via the network 60. The retail module 165R is configured to present a tiered pricing structure for purchase of the products and services offered through the memorabilia management system 10. For example, individual tiers and pricing are defined for access to and utilization of the audio comment on image webpage 600, the sounds effects webpage 700, the doodle on image webpage 800, and/or the video effects webpage 1300.

Although the invention has been described with reference to particular embodiments thereof, upon a reading and understanding of the foregoing disclosure, it will be understood by one of ordinary skill in the art that numerous variations and alterations to the disclosed embodiments will fall within the scope of this invention and of the appended claims.

What is claimed is:

1. A computer based system for management of memorabilia comprising:
a processor coupled to memory and an input-output controller;
a data store in communication with the processor;
an input device coupled to the input-output controller;
a display device coupled to the input-output controller;
the memory including at least one algorithm comprising
an initial processing section configured to upload a plurality of images and audio files having a plurality of data file formats;
an organization and storage section configured to determine at least one location within the data store for storage of each of the plurality of images and audio files; and
an access and display section configured for at least one of creating, retrieving, viewing, moving, annotating and transmitting the images and audio files.

2. The computer based system of claim 1, wherein the initial processing section is configured to upload the plurality of images and audio files coincident with a point-of-capture of the images and audio files.

3. The computer based system of claim 1, wherein the access and display section is configured to display the plurality of images and audio files in response to execution of a single command.

4. The computer based system of claim 1, wherein the access and display section is configured to selectively transmit at least one of the plurality of images and audio files to at least one predetermined receiver.

5. The computer based system of claim 1, wherein the initial processing section is configured to communicate with and receive the plurality of images and audio from at least two sources.

6. The computer based system of claim 1, wherein the initial processing section is configured to communicate with and receive the plurality of images and audio from at least two sources, simultaneously.

7. The computer based system of claim 1, wherein the data store comprises a cloud device accessible from a plurality of locations.

8. The computer based system of claim 1, wherein the access and display section is configured to enable users to create at least one of two and three dimensional renditions of the images.

9. The computer based system of claim 1, wherein the at least one algorithm is an application operable on a mobile telephone.

10. The computer based system of claim 1, wherein the at least one algorithm is operable on a website.

11. The computer based system of claim 1, wherein the access and display section is configured to host a virtual on-line store for at least one of fundraising and retail transactions.

12. The computer based system of claim 1, wherein the organization and storage section is configured determine at least one location within the data store for storage of each of the plurality of images and audio files coincident with the point-of-capture of the images and audio files.

13. The computer based system of claim 1, wherein the images include at least one of videos, photographs and artwork.

14. The computer based system of claim 1, wherein the at least one algorithm is in communication with a social media system.
